(19) United States
(12) Patent Application Publication
(10) Pub. No.: US 2010/0241733 A1
(43) Pub. Date: Sep. 23, 2010

(54) Contents transmitting ip adaptor transmitting contents to portable device and Contents transmitting method using the ip adaptor

(76) Inventors: Ga Jeong Shin, Seoul (KR); Hak Joo Lee, Ansan-si (KR)

Correspondence Address: LEXYOUME IP GROUP, LLC, 5180 PARKSTONE DRIVE, SUITE 175, CHANTILLY, VA, 20151, US

(21) Appl. No.: 12/308,547

(22) PCT Filed: Jun. 18, 2007
(86) PCT No.: PCT/KR2007/002949

§ 371 Date: Dec. 17, 2008

(30) Foreign Application Priority Data
Jun. 22, 2006 (KR) 10-2006-0056256

(51) Int. Cl. G06F 15/16

(52) U.S. Cl. 709/219; 709/224

(57) ABSTRACT

An Internet Protocol (IP) adaptor transmitting contents to a portable device which downloads contents corresponding to the portable device from a contents providing server and transmits the contents to the portable device, and a contents transmitting method using an IP adaptor is provided. The IP adaptor transmitting contents to the portable device includes: an IP address acquisition unit acquiring, from a predetermined recording unit by detecting a connection of the portable device, an IP address of a contents providing server which corresponds to the portable device; a network connection unit connecting with a network including the contents providing server which corresponds to the portable device by referring to the IP address of the contents providing server; a contents download unit downloading contents which correspond to the portable device from the contents providing server; and a contents transmission unit transmitting the downloaded contents to the portable device.

### CROSS-REFERENCE TO RELATED APPLICATION

This application claims priority from Korean Patent Application No. 10-2006-0056256, filed on Jun. 22, 2006, in the Korean Intellectual Property Office, the entire disclosure of which is incorporated herein by reference.

### BACKGROUND OF THE INVENTION

1. Field of the Invention

The present invention relates to a contents transmitting Internet Protocol (IP) adaptor which transmits contents to a portable device. More particularly, the present invention relates to a contents transmitting IP adaptor downloading contents which correspond to the portable device from a contents providing server and transmitting the contents to the portable device, and a contents transmitting method using the IP adaptor.

2. Description of Related Art

Recently, a great number of people use the Internet due to development of an ultra high speed data communication network, and users may easily access various multimedia contents. Particularly, use of a digital compression technology and sharing of the multimedia contents using the Internet and a peer to peer (P2P) method have been dramatically increased, and subsequently, a market for a portable device has been promoted. Moreover, the market for the portable device will be expanded due to the emergence of a portable multimedia player (PMP) playing multimedia contents, e.g. Motion Pictures Experts Group Audio Layer 3 (MP3) files and moving picture files.

Portable devices, such as a personal digital assistant (PDA) and a mobile phone, provide various functions, e.g. an MP3 function and a camera function along with a voice call service and a short message service, to satisfy customer's needs as communication technology has developed, and use by a user has increased.

In order to use multimedia contents in the portable devices, such as the MP3 player, the PMP, and a communication terminal, users are required to use built-in multimedia contents which is already built-in when purchasing the portable device or use multimedia contents from a contents providing server by downloading the multimedia contents.

As an example of a conventional method of the downloading the multimedia contents, the PDA downloads the multimedia contents using Active Sync. The Active Sync is a type of a program which can perform bi-directional data transmission by connecting a computer with the PDA, and is activated to download the multimedia contents in a specific folder of the computer to the PDA when mounting the PDA in a cradle which is connected with the computer. However, there are problems in this method, wherein the multimedia contents may be downloaded only after the computer is booted-up, a user is required to directly update the multimedia contents in the specific folder, and the Active Sync currently provided has problems of frequent errors when transmitting a large amount of data.

Also, as another example of a′ conventional method of downloading the multimedia contents, when downloading multimedia from portable devices, e.g. an MP3 player, a PMP and MP3 phone, a sync program, corresponding to each of the portable devices, is required to installed in a computer, and subsequently the multimedia may be downloaded by operating the sync program after connecting the portable device with the computer. However, there are problems in this method, the multimedia contents may also be downloaded only after the computer is booted-up, the sync program is required to be operated, downloadable multimedia contents are limited to music contents and moving picture contents, and a consumer is required to undergo a complicated purchase process to download purchased multimedia contents.

Also, as another example of a conventional method of downloading the multimedia contents, multimedia contents are transmitted to the portable device using Window Explorer, i.e. a file transfer method provided by Microsoft Windows. However, in this method, a computer is required to store the multimedia contents to transfer the multimedia contents using the Window Explorer, therefore a user is required to directly search for desired multimedia contents over the Internet, store the desired multimedia contents in the computer by downloading the desired multimedia contents from the located multimedia contents, and then may transmit the stored multimedia contents from the Window Explorer to the portable device. In this instance, there are problems in that the user is required to search for and store the multimedia every time, and purchased multimedia contents may not be transmitted to the portable device.

### SUMMARY OF THE INVENTION

The present invention provides an Internet Protocol (IP) adaptor and contents transmitting method using the IP adaptor which can download contents corresponding to a portable device from a contents providing server, and transmit the downloaded contents to the portable device without a PC since the portable device is automatically detected when a user attaches the portable device with the IP adaptor.

The present invention also provides an IP adaptor and contents transmitting method using the IP adaptor which can easily download users' desired Contents in a portable device without a PC by downloading contents according to predetermined contents download condition information and transmitting the downloaded contents to the portable device.

The present invention also provides an IP adaptor and contents transmitting method using the IP adaptor which can easily download contents for users without a PC since the contents corresponding to each portable device can be transmitted to the portable device by downloading the contents from a contents providing server corresponding to each portable device.

According to an aspect of the present invention, there is provided an IP adaptor transmitting contents to a portable device, the IP adaptor including: an IP address acquisition unit acquiring, from a predetermined recording unit by detecting a connection of the portable device, an IP address of a contents providing server which corresponds to the portable device; a network connection unit connecting with network including the contents providing server which corresponds to the portable device by referring to the IP address of the contents providing server; a contents download unit downloading contents which corresponds to the portable device from the contents providing server; and a contents transmission unit transmitting the downloaded contents to the portable device.

According to another aspect of the present invention, there is provided a contents transmitting method using an IP adaptor, the method including: acquiring an IP address of a contents providing server which corresponds to a portable device from a predetermined recording unit by detecting a connection of the portable device; connecting, by referring to the IP address of the contents providing server, a network with the contents providing server which correspond to the portable device; downloading contents which correspond to the portable device from the contents providing server; and transmitting the downloaded contents to the portable device.

In this case, the IP adaptor connects the portable device with the contents providing server. Accordingly, the portable device may download desired contents via a network without a PC.

For reference, the portable device used in this specification may include any one of a mobile phone, an MP3 player, and a portable multimedia player. Also, the contents used in this specification may include all files which can be played in the portable device, e.g. an MP3 file, a music file such as a WMA file, a moving picture file such as a WMV file and an MPG file, an E-book, an HTML article file, a text file, an image file, a game file, and a flash file.

### BRIEF DESCRIPTION OF THE DRAWINGS

The above and other aspects and advantages of the present invention will become apparent and more readily appreciated from the following detailed description of certain exemplary embodiments of the invention, taken in conjunction with the accompanying drawings of which:

FIG. 1 is a diagram illustrating a network configuration which includes an IP adaptor according to an exemplary embodiment of the present invention;

FIG. 2 is a block diagram illustrating an inner configuration of an IP adaptor according to an exemplary embodiment of the present invention;

FIG. 3 is a block diagram illustrating an example of an IP address acquisition unit of the IP adaptor of FIG. 2;

FIG. 4 is a block diagram illustrating an example of a network connection unit of FIG. 2;

FIG. 5 is a diagram illustrating an example of an input of the contents download condition information according to an exemplary embodiment of the present invention;

FIG. 6 is a diagram illustrating an example of the contents transmission unit of FIG. 2;

FIG. 7 is a flowchart illustrating contents transmitting method using an IP adaptor according to an exemplary embodiment of the present invention;

FIG. 8 is a flowchart illustrating an example of detecting the connection of the portable device of FIG. 7; and

FIG. 9 is a flowchart illustrating the contents transmitting method of FIG. 7 to the portable device.

### DETAILED DESCRIPTION OF EXEMPLARY EMBODIMENTS OF THE INVENTION

Reference will now be made in detail to exemplary embodiments of the present invention, examples of which are illustrated in the accompanying drawings; wherein like reference numerals refer to the like elements throughout. The exemplary embodiments are described below in order to explain the present invention by referring to the figures.

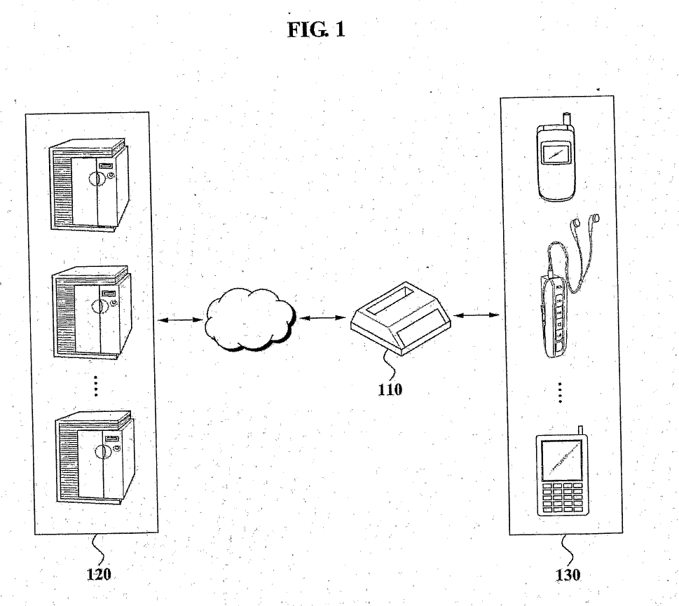

FIG. 1 is a diagram illustrating a network configuration which includes an IP adaptor 110 according to an exemplary embodiment of the present invention.

Referring to FIG. 1, the IP adaptor 110 acquires an IP address of a contents providing server 120 which corresponds to the portable device 130 from a predetermined recording unit by detecting a connection of the portable device 130. In this case, the IP adaptor 110 may be connected with a cradle capable of supporting the portable device 130.

The IP adaptor 110 connects with a network including the contents providing server 120 which corresponds to the portable device 130 by referring to the acquired IP address of the contents providing server 120, and downloads the contents which corresponds to the portable device 130 from the contents providing server 120 to transmit the contents to the portable device 130.

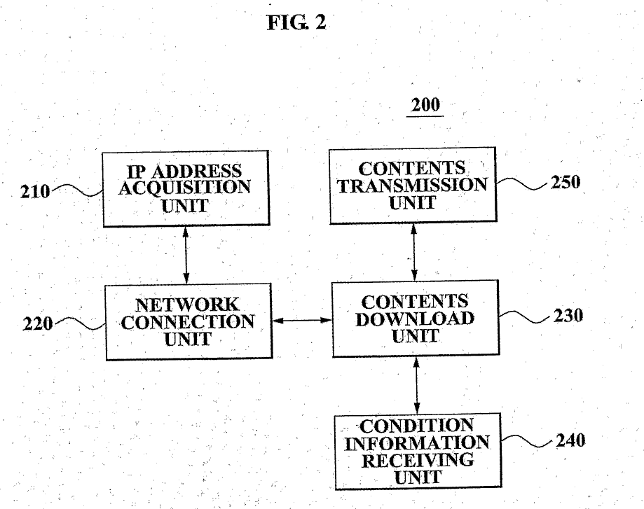

FIG. 2 is a block diagram illustrating an inner configuration of an IP adaptor 200 according to an exemplary embodiment of the present invention.

Referring to FIG. 2, the IP adaptor 200 includes an IP address acquisition unit 210, a network connection unit 220, a contents download unit 230, a condition information receiving unit 240, and a contents transmission unit 250.

According to the exemplary embodiment of the present invention, the IP adaptor 200 may be connected with a cradle capable of supporting the portable device 130 of FIG. 1.

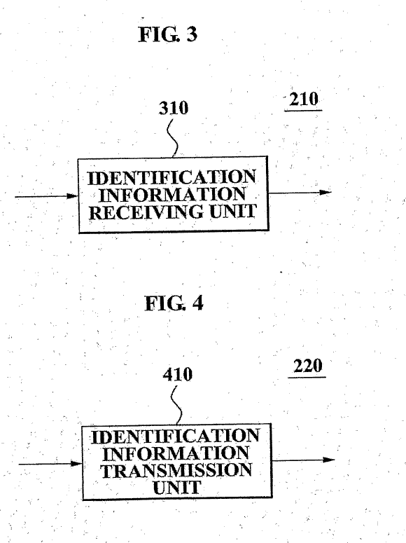

The IP address acquisition unit 210 acquires an IP address of the contents providing server 120 of FIG. 1 which corresponds to the portable device 130 of FIG. 1 from a predetermined recording unit by detecting a connection of the portable device 130 of FIG. 3.

As an example, when a user attaches an MP3 player to the IP adaptor 200, the IP address acquisition unit 210 acquires the IP address of the contents providing server 120 of FIG. 1 which corresponds to the MP3 player from the predetermined recording unit by detecting a connection of the MP3 player. The IP adaptor 200 may have its own corresponding IP address.

According to the exemplary embodiment of the present invention, the recording unit may record an IP address of each of contents providing servers which corresponds to at least one portable device. Also, according to the present invention, the IP address which corresponds to at least one portable device and is recorded in the recording unit may be added and updated according to an input of a user. As an example, the recording unit may record “120.8.104.100” as an IP address of the contents providing server 120 of FIG. 1 which corresponds to an MP3 player and record “210.0.10.151” as an IP address of the contents providing server 120 of FIG. 1 which corresponds to a PMP.

FIG. 3 is a diagram illustrating an example of the IP address acquisition unit 210 of the IP adaptor of FIG. 2.

Referring to FIG. 3, the IP address acquisition unit 210 of FIG. 2 includes an identification information receiving unit 310. The identification information receiving unit 310 receives identification information of the portable device 130 of FIG. 1.

The IP address acquisition unit 210 of FIG. 2 acquires an IP address of the contents providing server 120 of FIG. 1 which corresponds to the portable device 130 of FIG. 1 from a predetermined recording unit by referring to the identification information. Specifically, the recording unit may record an IP address of each of the contents providing server 120 of FIG. 1 by corresponding to the identification information of at least one portable device, and the IP address acquisition unit 210 may acquire an IP address of the contents providing server 120 of FIG. 1 which corresponds to the identification information of the portable device 130 of FIG. 1.

Referring back to FIG. 2, the network connection unit 220 connects with a network including the contents providing server 120 of FIG. 1 which corresponds to the portable device 130 of FIG. 1 by referring to the IP address of the contents providing server 120 of FIG. 1.

FIG. 4 is a block diagram illustrating an example of a network connection unit 220 of FIG. 2.

Referring to FIG. 4, the network connection unit 220 includes an identification information transmission unit 410. The identification information transmission unit 410 may transmit identification information of the portable device to the contents providing server when the contents providing server is connected with a network. The contents providing server is connected with the IP adaptor 200 of FIG. 2 using predetermined wired/wireless communication networks. An Integrated Services Digital Network (ISDN), an Asymmetric Digital Subscriber Line (ADSL), a Local Area Network (LAN), an Ethernet network, a Transmission Control Protocol/Internet protocol (TCP/IP) network, and an optical communication network may be used for the predetermined wire/wireless communication networks.

The identification information according the current embodiment may further include user information of the portable device. Specifically, the contents providing server authorizes the portable device using the transmitted identification information or user information of the portable device, and transmits contents corresponding to the portable device by searching contents information associated with the portable device.

Referring back to FIG. 2, the contents download unit 230 requests the contents providing server for contents corresponding to the portable device, and downloads the contents after completion of payment for the contents. Specifically, payment information is recorded in the recording unit, and the contents download unit 230 may download the contents corresponding to the portable device after completion of payment for the contents which corresponds to the portable device by referring to the recording unit.

Also, according to another embodiment of the present invention, the contents download unit 230 downloads the contents which correspond to the portable device from the contents providing server according to the contents download condition information which is stored in the contents providing server in association with the portable device.

According to the current embodiment, the user registers the contents download condition information associated with the portable device by connecting to the contents providing server via the wire/wireless communication networks in a user terminal. The user terminal may include a computer terminal or a communication terminal. As an example, the user may establish the contents download condition information to download broadcasting contents in the portable device when the portable device is a PMP, and when predetermined broadcasting contents is uploaded in the contents providing server. As another example, the user may establish the contents download condition information to download music contents corresponding to “in twenties”, “latest song”, and “ballad”, when the portable device is an MP3 player. Also, according to another embodiment of the present invention, the user may register the contents download condition information using a phone in the contents providing server.

Also, according to the other embodiment of the present invention, the condition information receiving unit 240 receives contents download condition information from the portable device, and the contents download unit 230 downloads the contents which corresponds to the portable device according to the contents download condition information from the contents providing server.

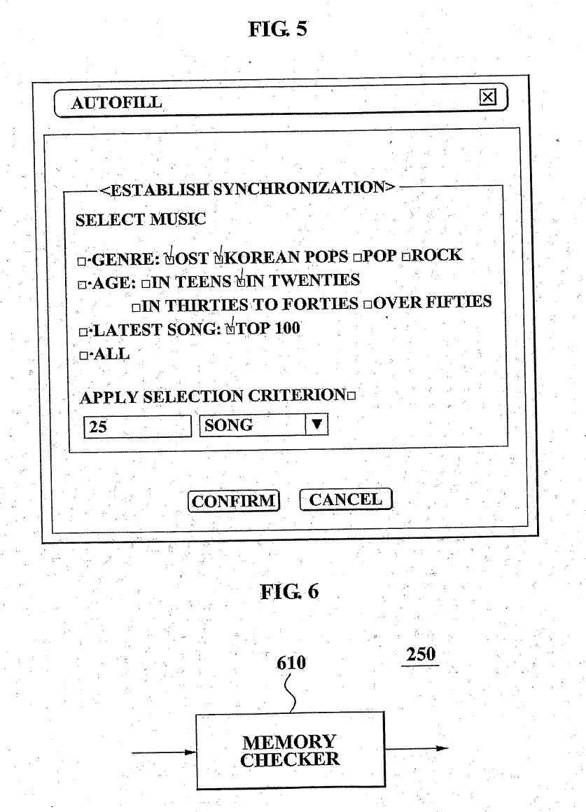

FIG. 5 is a diagram illustrating an example of an input of the contents download condition information according to an exemplary embodiment of the present invention.

FIG. 5 may be a screen displayed in the portable device which is connected with an IP adaptor, or in a user terminal which is connected with the contents providing server using a wired/wireless communication networks.

Referring to FIG. 5, the user selectively inputs the contents download condition information by each category, such as a genre and an age, via a user interface by selectively inputting the contents download condition information, for example, “genre: OST, popular songs”, “age: in teens, in twenties”, “latest song: top 100”, and the condition information receiving unit 240 receives the inputted contents download condition information.

Also, according to another embodiment of the present invention, the contents download unit 230 downloads the contents by including a license which corresponds to the contents from the contents providing server. The license according to another embodiment of the present invention may be issued from a license issuing server in order to correspond to the portable device. Namely, as an example, the contents providing server transmits a license request of the contents, including identification information of the portable device, to the license issuing server, and transmits the license to the IP adaptor 200 by receiving the license of the contents corresponding to the portable device from the license issuing server according to the license request.

The contents transmission unit 250 transmits the downloaded contents to the portable device.

FIG. 6 is a diagram illustrating an example of the contents transmission unit 250 of FIG. 2.

Referring to FIG. 6, the contents transmission unit includes a memory checker 610. The memory checker 610 checks memory information of the connected portable device, and the contents transmission unit 250 of FIG. 2 transmits the downloaded contents to the portable device according to a predetermined criterion when available memory is less than a predetermined reference value as a result of the checking by the memory checker 610.

According to an embodiment of the present invention, the contents transmission unit 250 of FIG. 2 transmits the downloaded contents to the portable device according to a time priority with respect to the contents when the available memory is less than the predetermined reference value as the result of the checking of the memory checker 610.

According to another embodiment of the present invention, the contents transmission unit 250 of FIG. 2 may transmit the downloaded contents by randomly selecting to delete at least one content which is stored in the portable device, or controlling to delete the at least one content in an order of older files, when the available memory is less than the predetermined reference value as the result of the checking of the memory checker 610.

According to still another embodiment of the present invention, the contents transmission unit 250 of FIG. 2 may cancel the transmission of the contents when the available memory is less than the predetermined reference value as the result of the checking of the memory checker 610.

According to the embodiments of the present invention, the user may establish download setting corresponding to the contents which is transmitted from the IP adaptor, via a user interface in the portable device, which is connected with the IP adaptor, or in a user terminal, which is connected with the contents providing server by a wired/wireless communication network, when the available memory of the portable device is less than the predetermined reference value, and the contents transmission unit 250 may transmit the downloaded contents to the portable device according to the download setting when the available memory is less than the predetermined reference value. As an example, the download establishment may include random file deletion, older file deletion, and contents transmission cancellation.

Also, according to the another embodiment of the present invention, the contents download unit 230 may record the contents in the recording unit by downloading the contents which corresponds to each portable device from the contents providing server according to the content download condition information. The contents transmission unit 250 may transmit the downloaded contents corresponding to the portable device to the portable device when the portable device is connected.

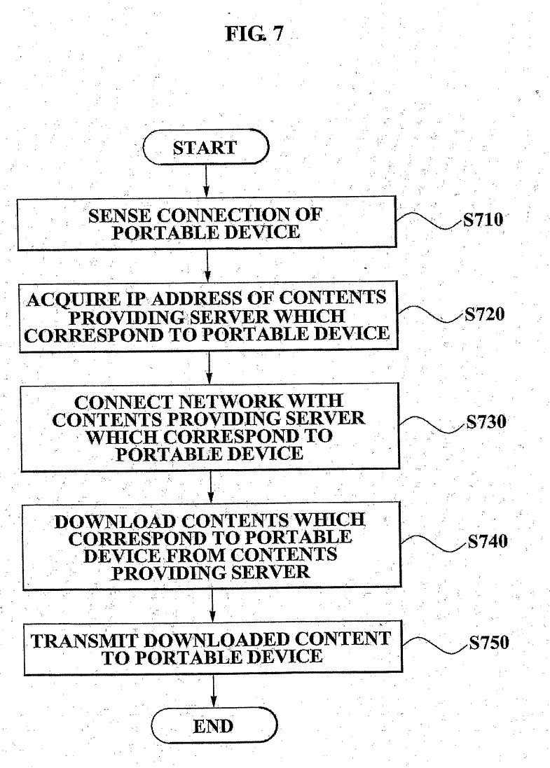

FIG. 7 is a flowchart illustrating contents transmitting method using an IP adaptor according to an exemplary embodiment of the present invention.

Referring to FIG. 7, in operation S710, the contents transmitting method using the IP adaptor detects connection of the portable device. According to an embodiment of the present invention, the IP adaptor may be connected with a cradle capable of supporting the portable device.

Also, in operation S720, the contents transmitting method using the IP adaptor acquires an IP address of a contents providing server which corresponds to the portable device from a predetermined recording unit by detecting the connection of the portable device.

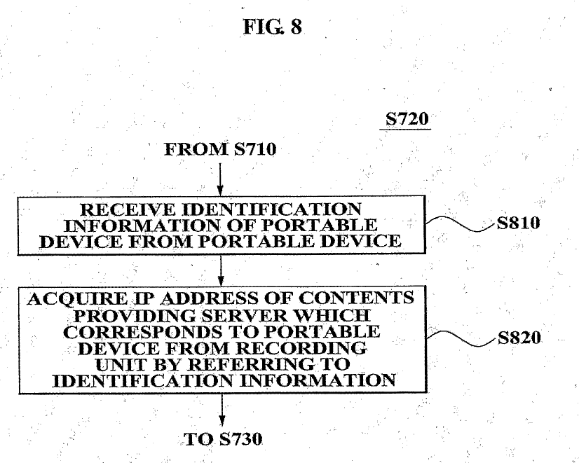

FIG. 8 is a flowchart illustrating an example of the detecting the connection of the portable device of FIG. 7.

Referring to FIG. 8, in operation S810, the contents transmitting method using the IP adaptor receives identification information of the portable device from the portable device.

Also, in operation S820, the contents transmitting method using the IP adaptor acquires the IP address of the contents providing server which corresponds to the portable device from a recording unit by referring to the identification information.

Referring back to FIG. 7, in operation S730, the contents transmitting method using the IP adaptor connects a network with the contents providing server which corresponds to the portable device by referring to the IP address of the contents providing server.

According to an embodiment of the present invention, the contents transmitting method using the IP adaptor transmits the identification information of the portable device to the contents providing server.

Also, in operation S740, the contents transmitting method using the IP adaptor downloads the contents which corresponds to the portable device from the contents providing server.

According to an embodiment of the present invention, the contents transmitting method using the IP adaptor downloads the contents which corresponds to the portable device from the contents providing server according to the contents download condition information which is stored in the contents providing server in association with the portable device.

Also, according to another embodiment of the present invention, the contents transmitting method using the IP adaptor receives the contents download condition information from the connected portable device, and downloads the contents corresponding to the portable device from the contents providing server according to the received contents download condition information from the portable device.

Also, according to still another embodiment of the present invention, the contents transmitting method using the IP adaptor downloads the contents by including a license which corresponds to the contents from the contents providing server.

In operation S750, the contents transmitting method using the IP adaptor transmits the downloaded contents to the portable device.

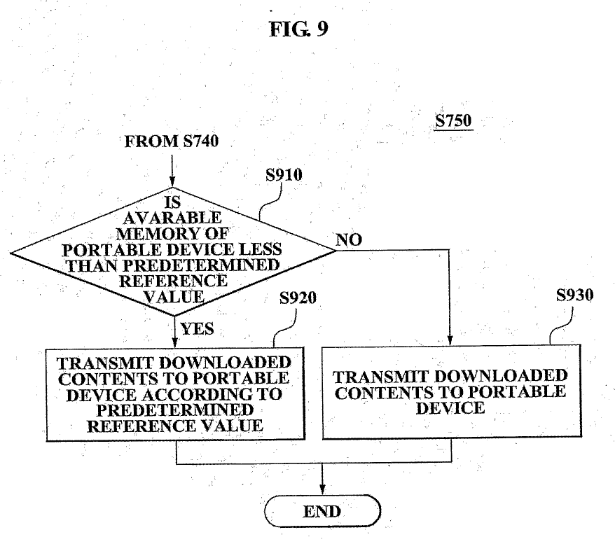

FIG. 9 is a flowchart illustrating the contents transmitting method of FIG. 7 to the portable device.

Referring to FIG. 9, in operation S910, the contents transmitting method using the IP adaptor checks memory information of the connected portable device. Specifically, the contents transmitting method using the IP adaptor may check whether available memory is less than a predetermined reference value by comparing the memory information of the connected portable device with size information of a file.

Also, in operation S920, the contents transmitting method using the IP adaptor transmits the downloaded contents to the portable device depending upon the result of operation S910 in which the memory checker checks available memory against a predetermined reference value.

According to an embodiment of the present invention, the contents transmitting method using the IP adaptor transmits the downloaded contents to the portable device according to a time priority with respect to the downloaded contents.

Also, in operation S930, the contents transmitting method using the IP adaptor transmits the downloaded contents to the portable device when the available memory is not greater than the predetermined reference value as the result of the checking in the operation S910.

Also, according to another embodiment of the present invention, the contents transmitting method using the IP adaptor records the contents in a recording unit by downloading the contents which corresponds to the each portable device according to the contents download condition information, and transmits the downloaded contents to the portable device.

The contents transmitting method using the IP adaptor according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, contents corresponding to a portable device may be downloaded from a contents providing server, and the downloaded contents may be transmitted to the portable device without a PC since the portable device is detected when a user attaches the portable device with the IP adaptor.

Also, according to the present invention, a user may easily download desired contents in a portable device without a PC by downloading contents according to predetermined contents download condition information and transmitting the downloaded contents to the portable device.

Also, according to the present invention, a user may easily download contents without a PC since the contents corresponding to each portable device can be transmitted to the portable device by downloading the contents from a contents providing server corresponding to each portable device.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An Internet Protocol (IP) adaptor transmitting contents to a portable device, the IP adaptor comprising:
an IP address acquisition unit acquiring, from a predetermined recording unit by detecting a connection of the portable device, an IP address of a contents providing server which corresponds to the portable device;
a network connection unit connecting with a network including the contents providing server which corresponds to the portable device by referring to the IP address of the contents providing server;
a contents download unit downloading contents which correspond to the portable device from the contents providing server; and
a contents transmission unit transmitting the downloaded contents to the portable device.

2. The IP adaptor of claim 1, wherein the IP adaptor is connected with a cradle capable of supporting the portable device.

3. The IP adaptor of claim 1, wherein the contents download unit downloads the contents which correspond to the portable device from the contents providing server, according to contents download condition information, which is stored in the contents providing server in association with the portable device.

4. The IP adaptor of claim 1, further comprising:
a condition information receiving unit receiving the contents download condition information from the portable device,
wherein the contents download unit downloads the contents which correspond to the portable device from the contents providing server, according to the contents download condition information.

5. The IP adaptor of claim 1, wherein the contents download unit downloads the contents by including a license which corresponds to the contents from the contents providing server.

6. The IP adaptor of claim 1, wherein the contents transmission unit comprises a memory checker which checks memory information of the connected portable device, and transmits the downloaded contents to the portable device when available memory is less than a predetermined reference value as a result of the checking of the memory checker.

7. The IP adaptor of claim 6, wherein the contents transmission unit transmits the downloaded contents to the portable device according to a time priority with respect to the downloaded contents.

8. The EP adaptor of claim 1, wherein the IP address acquisition unit comprises:
an identification information receiving unit receiving identification information of the portable device, and acquires the IP address of the contents providing server which corresponds to the portable device from the recording unit by referring to the identification information, and
the network connection unit comprises an identification information receiving unit which transmits the identification information of the portable device to the contents providing server.

9. A contents transmitting method using an IP adaptor, the method comprising:
acquiring an IP address of a contents providing server which corresponds to a portable device from a predetermined recording unit by detecting a connection of the portable device;
connecting, by referring to the IP address of the contents providing server, a network with the contents providing server which corresponds to the portable device;
downloading contents which correspond to the portable device from the contents providing server; and
transmitting the downloaded contents to the portable device.

10. The method of claim 9, wherein the IP adaptor is connected with a cradle capable of supporting the portable device.

11. The method of claim 9, wherein the downloading the contents which corresponds to the portable device from the contents providing server downloads the contents which corresponds to the portable device from the contents providing server, according to contents download condition information which is stored in the contents providing server in association with the portable device.

12. The method of claim 9, further comprising:
receiving the contents download condition information from the connected portable device,
wherein the downloading of the contents downloads the contents which corresponds to the portable device from the contents providing server, according to the contents download condition information.

13. The method of claim 9, wherein the downloading of the contents downloads the contents by including a license which corresponds to the contents from the contents providing server.

14. The method of claim 9, wherein the transmitting of the downloaded contents to the portable device comprises:
checking memory information of the connected portable device; and
transmitting the downloaded contents to the portable device when available memory is less than a predetermined reference value as a result of the checking of the memory checker.

15. The method of claim 14, wherein the transmitting the downloaded contents to the portable device transmits the downloaded contents to the portable device according to a time priority with respect to the downloaded contents.

16. The method of claim 9, wherein the detecting of the connection of the portable device comprises:
receiving identification information of the portable device from the portable device;
acquiring the IP address of the contents providing server which corresponds to the portable device from the recording unit by referring to the identification information; and
the connecting of the network with the contents providing server which corresponds to the portable device comprises transmitting the identification information of the portable device to the contents providing server.

17. A computer-readable storage medium storing a program for implementing the contents transmitting method via an IP adaptor;
acquiring an IP address of a contents providing server which corresponds to a portable device from a predetermined recording unit by detecting a connection of the portable device;
connecting, by referring to the IP address of the contents providing server, a network with the contents providing server which corresponds to the portable device;
downloading contents which corresponds to the portable device from the contents providing server; and
transmitting the downloaded contents to the portable device.
